(19) United States
(12) Patent Application Publication
(10) Pub. No.: US 2009/0317915 A1
(43) Pub. Date: Dec. 24, 2009

(54) Biochip detection device and detection method therof

(76) Inventors: Shu-Jen Han, Sindian City (TW); Joseph Shu-Tzu Han, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,700

(22) Filed: May 20, 2009

(30) Foreign Application Priority Data
Jun. 18, 2008 (TW) 097122624

(51) Int. Cl. G01N 27/00

(52) U.S. Cl. 436/149; 422/82.01

(57) ABSTRACT

The present invention provides a biochip detection device and a detection method thereof. The detection device includes a detection circuit and a biochip containing a plurality of sensor modules. Each sensor modules includes a plurality of giant magnetoresistive biosensors. The detection circuit is arranged to have an end of each biosensor and an end of each of reference sensors respectively connected to first and second voltage sources, whereby current variation induced in each biosensor can be added together. The detection method includes the steps of providing the above described biochip; carrying out surface functionalization on the biosensors; spotting surfaces of the biosensors with probe molecules corresponding to target molecules to complete molecule immobilization; applying a purified sample to the biochip so that target molecules existing in the sample bind to the probe molecules on the surfaces of the biosensors; applying detecting molecules that are combined with magnetic nano-particles to the biochip in such a way that the detecting molecules are complementary to and thus bound to the target molecules; and using the above mentioned detection circuit to supply an output of a detection current of the biosensors so that observation of variation thereof is made to determine existence of the target molecules.

### FIELD OF THE INVENTION

The present invention relates to a biochip detection device and a detection method thereof, and in particular to a biochip detection device that is advantageous of low costs, excellent portability, and high detection sensitivity and a detection method thereof, which are applicable to all sorts of chips and inspection of all sorts of liquid.

### BACKGROUND OF THE INVENTION

A conventional bio-detection system that uses fluorescence based techniques often comprises bulky and expensive optic inspection equipments. Due to such a limitation in respect of costs and bulkiness, such optics based inspection devices cannot be made popular, and are only found in laboratory applications. Thus, it is of an urgent need of a novel bio-detection system that is of low costs, excellent portability, and high sensitivity.

The conventional biosensor is often arranged as a “single” and “bulky” sensor in order to increase the surface coverage rate and to shorten the time period necessary for molecules to spread into the sensor. However, such a bulky sensor needs a large amount of molecules in order to generate a sufficiently strong signal and this makes the sensitivity of such a device very low.

Further, it was also observed that even a plurality of small-sized sensors is integrated in a bio-detection system, each sensor can only be independently operated for detection and the variation of current caused by change of resistance of each of such biosensors cannot be added together, making it difficult to determine if a target molecule exists. Again, the sensitivity of detection is low.

Thus, it is desired to provide a biochip detection device and a detection method that offer low costs, excellent portability, and high detection sensitivity, and at the same time increase the surface coverage rate.

### SUMMARY OF THE INVENTION

A first objective of the present invention is to provide a biochip detection device and a detection method thereof, wherein distributively arranged and magnetism based biosensors are integrated with the biochip and the biochip is made with a complementary metal oxide semiconductor (CMOS) process or a CMOS-compatible process and operated in a current integrated measurement mode, so as to make it possible for mass production to achieve reduction of costs. Further, the distributive arrangement of the biosensors and the use of the current integrated type measurement mode make it possible to: shorten the time period necessary for molecules to spread into the biosensors and enhance the sensitivity of detection. Further, direct generation of electric signals from the biosensors makes it possible to simplify (with reduced costs) a signal reading apparatus and thus allowing it to be easily carried. Further, uniform distribution of the biosensors in each module makes it possible to provide an optimum surface coverage rate.

A second objective of the present invention is to provide a biochip detection device and a detection method thereof, wherein addition of the current variation occurring in each biosensor together makes it possible to enlarge the level of variation that was previously tiny and hard to read in order to facilitate reading and comparison. In other words, the detection sensitivity is enhanced.

A third objective of the present invention is to provide a biochip detection device and a detection method thereof, wherein simultaneous applications of AC magnetic field and AC voltage make it possible to lower noise and reduce signal drifting thereby enhancing resolution of the detection device.

A fourth objective of the present invention is to provide a biochip detection device and a detection method thereof, wherein application of magnetic fields generated by magnetic nano-particles to alter electric resistance of the biosensor for detection of current variation makes it possible to detect the existence of the magnetic nano-particles, and detection of the existence of the magnetic nano-particles indicates the existence of target molecules in the sample detected.

To realize the above objectives, the present invention provides a biochip detection device comprising at least one biochip and a plurality of detection circuits. The biochip comprises a plurality of sensor modules, and each sensor module comprises a plurality of uniformly distributed giant magnetoresistive (GMR) biosensor. The biosensors of each module can be covered by a single molecule spot. The detection circuits are electrically connected to the biochip and each detection circuit comprises a first voltage source, a second voltage source, a plurality of reference sensors, a first amplifier, a second amplifier, and a third amplifier. The first voltage source is electrically connected to an end of each biosensor of each module to apply a voltage thereto. Each biosensor has an opposite end connected to the first amplifier that supplies an output of detection current. Each reference sensor is set beside each respective biosensor, and each reference sensor has an end connected to the second voltage source to be applied with a voltage and an opposite end connected to the second amplifier that supplies an output of reference current. The third amplifier receives the outputs of the first and second amplifiers and, after making a comparison, supplies a final detection value through which observation of variation can be made. As such, the time period for molecules to spread into the GMR biosensors is shortened and the sensitivity of detection is enhanced.

A first detection method of the biochip detection device provided by the present invention is to detect the existence of target molecules, comprising the following steps: (a) providing a biochip; (b) surface functionalization; (c) immobilization of probe molecule; (d) application of sample; (e) application of detecting molecule; and (f) measurement of output of detection value. In step (a) of providing a biochip, a plurality of biosensor modules is provided on the biochip and each biosensor module comprises a plurality of GMR biosensors. In step (b) of surface functionalization, surface functionalization is carried out on each biosensor. In step (c) of immobilization of probe molecule, a surface of each biosensor is spotted with a probe molecule corresponding to the target molecule to complete molecule immobilization. In step (d) of application of sample, a purified sample is applied to the biochip so that target molecules existing in the sample bind to the probe molecules on the surfaces of the biosensors. In step (e) of application of detecting molecule, detecting molecules that are combined with magnetic nano-particles are applied to the biochip, wherein the detecting molecules are complementary to and thus bound to the target molecules. In step (f) of measurement of output of detection value, at least one detection circuit is used to supply an output of a detection current of the biosensors and observation of variation thereof is made to determine existence of the target molecules.

A second detection method of the biochip detection device provided by the present invention is identical to the first detection method and the only difference resides in steps (d) and (e): where in modified step (d1) of combination of detecting molecule with target molecule, detecting molecules carrying magnetic nano-particles are combined in advance with target molecules contained in a sample in an external environment; in modified step (d2) of purification of sample, an external magnetic field is applied to the external environment to purify the sample; and in modified step (e) of application of sample, the purified sample with magnetic nano-particles attached thereto is applied to the biochip to bind to the probe molecules on the surfaces of the biosensors.

The efficacies that can be achieved with the present invention are that the biochip is suitable for mass production with a reduced cost; that the time period necessary for molecules to spread into the GMR biosensors is shortened and the sensitivity of detection is enhanced; carrying is made easy; and an optimum surface coverage rate is provided.

### BRIEF DESCRIPTION OF THE DRAWINGS

The present invention will be apparent to those skilled in the art by reading the following description of a preferred embodiment thereof, as well as the best mode of a detection method thereof, with reference to the drawings, in which:

FIG. 1 is a plan view of a biochip detection device constructed in accordance with the present invention, wherein Part A shows an enlarged portion of the biochip detection device;

FIG. 2 is a schematic view of a circuit diagram in accordance with the biochip detection device of the present invention corresponding to Part A of FIG. 1;

FIG. 3 is a schematic view illustrating a detection method of the biochip detection device in accordance with a first embodiment of the present invention; and

FIG. 4 is a schematic view illustrating a detection method of the biochip detection device in accordance with a second embodiment of the present invention.

### DETAILED DESCRIPTION OF THE PREFERRED EMBODIMENT AND THE BEST MODE FOR CARRYING OUT THE INVENTION

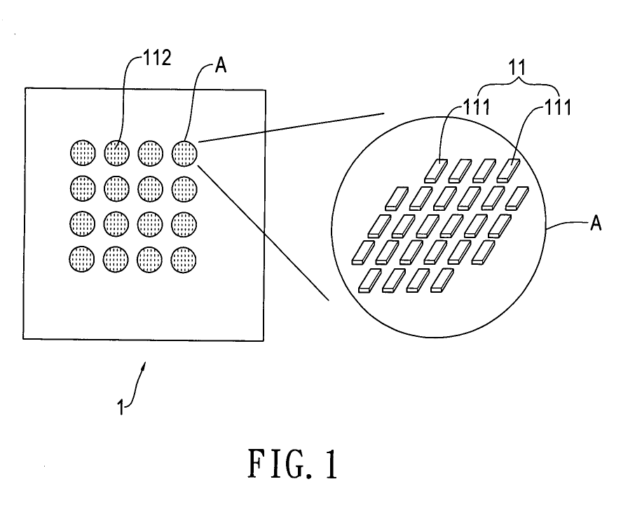

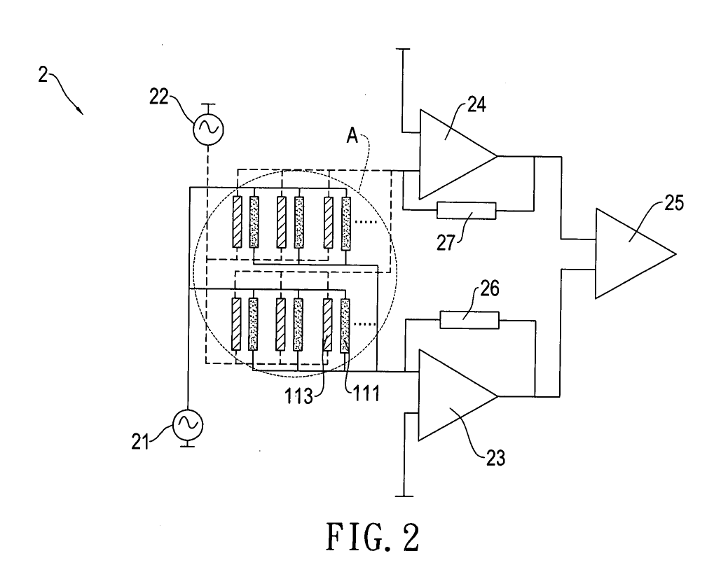

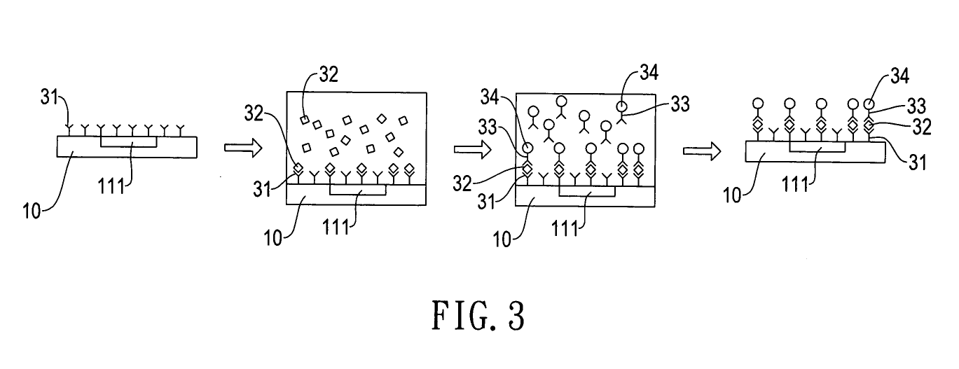

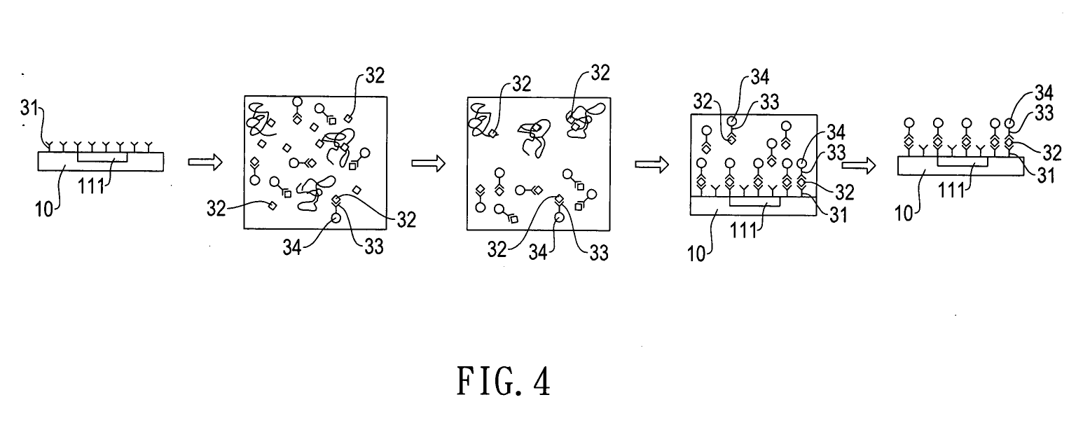

The present invention provides a biochip detection device and a detection method thereof for detecting the existence of a target molecule. FIGS. 1 and 2 show the biochip detection device in accordance with the present invention and FIGS. 3 and 4 demonstrate a detection method of the biochip detection device in accordance with first and second embodiments of the present invention.

Referring to FIG. 1, the biochip detection device in accordance with the present invention comprises at least one biochip 1 and a plurality of detection circuits 2.

Each biochip 1 comprises a plurality of sensor modules 11, which is arranged in an array. Each sensor module 11 comprises a plurality of giant magnetoresistive (GMR) biosensors 111 to form a distributive GMR biosensor arrangement. Each module 11 is of a size having a diameter between 50 μm and 100 μm for compatibility with spot size generated by market-available DNS spotting equipments. Each module 11 is comprised of a plurality of tiny GMR biosensors 111 that is formed through photolithography patterning. In each module 11, all the biosensors 111 can be covered by a single molecule spot 112. Each biosensor 111 is of a size that has a length (or width) of micrometers and a width (or length) of micrometers to sub-micrometers in order to realize extremely high detection sensitivity. Further, the biosensors 111 are uniformly distributed in each module 11 in order to provide an optimum surface coverage rate. Further, the biosensors 111 are integrated in the biochip 1 and the biosensors 111 are giant magnetoresistive type magnetism based biosensors, whereby the electric resistance of the biosensor 111 varies with an externally applied magnetic field.

The detection circuits 2 are electrically connected to the biochip 1. Each detection circuit 2 comprises a first voltage source 21, a second voltage source 22, a plurality of reference sensors 113, a first amplifier 23, a second amplifier 24, and a third amplifier 25. The first voltage source 21 is electrically connected to an end of each biosensor 111 of each module 11 to apply a voltage thereto. Each biosensor 111 has an opposite end electrically connected to the first amplifier 23 so that the first amplifier 23 generates an output of detection current. Each reference sensor 113 is set beside each respective biosensor 111. Each reference sensor 113 has an end electrically connected to the second voltage source 22 to be applied with a voltage and an opposite end connected to the second amplifier 24 so that the second amplifier 24 generates an output of reference current. The third amplifier 25 receives the outputs of the first and second amplifiers 23, 24 and, after making a comparison, supplies a final detection value through which observation of variation can be made. As such, electrical current induced by a variation of electrical resistance of each biosensor 111 can be added up and the addition enlarges the variation to facilitate reading and comparison. In addition, the time period that molecules need to spread into the biosensors 111 can be shortened and the sensitivity of detection can be enhanced. In other words, the detection current obtained through summing up the constituent components from all the biosensor 111 of the module 11 will be compared with the reference current obtained through summing up constituent components from all the reference sensors 113. Further, the detection current and the reference current obtained through the addition processes can enlarge the variations of the currents in order to facilitate reading and comparison. This is a “current integrated” type measurement mode.

The biochip 1 is made with a complementary metal oxide semiconductor (CMOS) process or a CMOS-compatible process. The detection circuits 2 can be arranged on a circuit board (not shown) of the biochip detection device. In Part A of FIG. 1, the biosensors 111 are shown to be electrically connected to the detection circuits 2 of FIG. 2. The first amplifier 23 is an inverted closed-loop amplifier (or a non-inverted closed-loop amplifier), and the second amplifier 24 is a non-inverted closed-loop amplifier (or an inverted closed-loop amplifier). The first and second voltage sources 21, 22 can be either direct-current (DC) voltage sources or alternate-current (AC) voltage sources. The detection circuit 2 may further comprise an externally applied magnetic field that is either an AC field or a DC field. Simultaneous applications of an AC magnetic field and an AC voltage can lower noise and reduce signal drifting, leading to enhanced resolution of the detection device. Further, the first and second amplifiers 23, 24 of the detection circuit 2 can be electrically and respectively connected with first and second resistors 26, 27 in parallel therewith.

Referring to FIG. 3, a detection method carried out with the biochip detection device in accordance with the first embodiment of the present invention for detecting the existence of target molecules will be described. The detection method comprises the following steps (each phase of the process demonstrated in FIG. 3 being illustrated with a cross-sectional view of a single biosensor 111):

(a) Providing a biochip: in which the biochip comprises a plurality of biosensor modules, and each biosensor module comprises a plurality of GMR biosensors 111, wherein the biochip comprises a substrate 10 and the biosensors 111 are electrically connected to the substrate 10;

(b) Surface functionalization: in which surface functionalization is carried out on each biosensor 111;

(c) Immobilization of probe molecule: in which a surface of each biosensor 111 is spotted with a probe molecule 31 corresponding to the target molecule to complete molecule immobilization;

(d) Application of sample: in which a “purified” sample is applied to the biochip so that if target molecules exist in the sample, then, as demonstrated in the second phase of FIG. 3, the target molecules 32 bind to the probe molecules 31 on the surfaces of the biosensors 111;

(e) Application of detecting molecule: in which detecting molecules 33 that are “combined with magnetic nano-particles 34” are applied to the biochip, wherein, as demonstrated in the third phase of FIG. 3, the detecting molecules 33 are complementary to and thus bound to the target molecules 32; and

(f) Measurement of output of detection value: in which at least one detection circuit is used to supply an output of a detection current of the biosensors 111 and observation of variation thereof is made to determine existence of the target molecules. In other words, the characteristics that the magnetic fields induced by the magnetic nano-particles 34 can alter the resistances of the biosensors 111 and variation of current can thus be detected is employed to detect and determine the existence of the magnetic nano-particles 34, which indicates presence of the target molecules in the sample.

Referring to FIG. 4, a detection method carried out with the biochip detection device in accordance with the second embodiment of the present invention for detecting the existence of target molecules will be described. The detection method comprises the following steps (first, fourth, and fifth phases of the process demonstrated in FIG. 4 being illustrated with a cross-sectional view of a single biosensor 111):

(a) Providing a biochip;

(b) Surface functionalization;

(c) Immobilization of probe molecule; the above three steps being identical to those of the first embodiment;

(d1) Combination of detecting molecule with target molecule: in which detecting molecules 33 carrying magnetic nano-particles 34 are combined in advance with target molecules 32 contained in a sample in an “external environment”, and as demonstrated in the second phase of FIG. 4, the combination is not carried out on the biochip and instead, is carried out in the external environment and in a not-purified and random condition;

(d2) Purification of sample: in which an external magnetic field is applied to the external environment to purify the sample, and as demonstrated in the third phase of FIG. 4, the purification is neither carried out on the biochip and is instead in the external environment to convert or classify the random condition into a purified condition through the externally applied magnetic field;

(e) Application of sample: in which the purified sample with magnetic nano-particles 34 attached thereto is applied to the biochip, as demonstrated in the fourth phase of FIG. 4, to bind to the probe molecules 31 on the surfaces of the biosensors 111; and

(f) Measurement of output of detection value (this step being identical to the first embodiment): in which at least one detection circuit is used to supply an output of a detection current of the biosensors 111 and observation of variation thereof is made to determine existence of the target molecules. In other words, the characteristics that the magnetic fields induced by the magnetic nano-particles 34 can alter the resistances of the biosensors 111 and variation of current can thus be detected is employed to detect and determine the existence of the magnetic nano-particles 34, which indicates presence of the target molecules in the sample.

The processes in accordance with the first and second embodiments can be added with a step of repeatedly adding magnetic nano-particles after step (e). The step of repeatedly adding nano-particles provides an operation of repeatedly adding magnetic nano-particles 34, if desired, to have the newly added magnetic nano-particles 34 to combine with the previously present magnetic nano-particles for the purposes of amplification of signal. Further, also referring to FIG. 2, the detection methods in accordance with the first and second embodiments use a detection circuit 2 that is completely identical to the detection circuits arranged on the previously discussed biochip detection device, comprising a first voltage source 21, a second voltage source 22, a plurality of reference sensors 113, a first amplifier 23, a second amplifier 24, and a third amplifier 25. As such, the electric current induced by the variation of resistance of each biosensor 111 can be added together to facilitate reading and comparison. Further, the time period that molecules need to spread into the biosensors 111 can be shortened and the sensitivity of detection can be enhanced.

The detection method of both the first and second embodiments provide the same result of detection and the difference is that purification is carried out separately and early in the first embodiment, but is combined with one of the steps of the process of the second embodiment. Although the sequence is different, the result of detection is the same.

The detection methods of the first and second embodiments as illustrated in FIGS. 3 and 4, after measuring the detection value of the biosensor 111, still requires employment of the detection circuit 2 illustrated in FIG. 2 to carry out detection. The detection current obtained by adding the constituent components from all the biosensors 111 of each module 11 is compared with the reference current obtained by adding the constituent components from all the reference sensors 113. Further, the detection current and the reference current obtained through the addition processes can enlarge the variation of the current in order to facilitate reading and comparison.

The biochip detection device and the detection method thereof in accordance with the present invention offer the following features: (1) Integration of the distributively arranged and magnetism based biosensors 111 with a biochip 1, which is made with a CMOS process or a CMOS-compatible process and use of a current integrated type measurement mode make it possible for mass production to achieve reduction of costs. (2) The distributive arrangement of the biosensors 111 and the use of the current integrated type measurement mode make it possible to: shorten the time period necessary for molecules to spread into the biosensors 111 and enhance sensitivity of detection. (3) Addition of current variation of each biosensor 111 makes it possible to enlarge the level of variation that was previously tiny and hard to read in order to facilitate reading and comparison. (4) Direct generation of electric signal from the biosensor 111 makes it possible to simplify (and cost down) a signal reading apparatus and thus allowing it to be easily carried. (5) Uniform distribution of the biosensors 111 in each module 11 makes it possible to provide an optimum surface coverage rate. (6) Simultaneous applications of AC magnetic field and AC voltage make it possible to lower noise and reduce signal drifting thereby enhancing resolution of the detection device. (7) Application of magnetic fields generated by magnetic nano-particles 34 to alter electric resistance of the biosensor 111 for detection of current variation makes it possible to detect the existence of the magnetic nano-particles 34, and detection of the existence of the magnetic nano-particles 34 indicates the existence of target molecules in the sample detected.

Although the present invention has been described with reference to the preferred embodiment thereof, as well as the best mode for carrying out a detection method thereof, it is apparent to those skilled in the art that a variety of modifications and changes may be made without departing from the scope of the present invention which is intended to be defined by the appended claims.

What is claimed is:

1. A biochip detection device, comprising:
at least one biochip, which comprises a plurality of sensor modules, each sensor module comprising a plurality of uniformly distributed giant magnetoresistive (GMR) biosensors, the biosensors of each module being adapted to be covered by a single molecule spot; and
a plurality of detection circuits, which is electrically connected to the biochip, each detection circuit comprising a first voltage source, a second voltage source, a plurality of reference sensors, a first amplifier, a second amplifier, and a third amplifier, the first voltage source being electrically connected to an end of each biosensor of each module to apply a voltage thereto, each biosensor having an opposite end connected to the first amplifier that supplies an output of detection current, each reference sensor being set beside each respective biosensor, each reference sensor having an end connected to the second voltage source to be applied with a voltage and an opposite end connected to the second amplifier that supplies an output of reference current, the third amplifier receiving the outputs of the first and second amplifiers and, after making a comparison, supplying a final detection value through which observation of variation can be made;
whereby time period for molecules to spread into the GMR biosensors is shortened and sensitivity of detection is enhanced.

2. The biochip detection device as claimed in claim 1, wherein each module of the biochip is of a size having a diameter between 50 μm and 100 μm.

3. The biochip detection device as claimed in claim 1, wherein the biosensors and the reference sensors either have a length of micrometers and a width of micrometers to sub-micrometers, or have a width of micrometers and a length of micrometers to sub-micrometers to improve detection sensitivity thereof.

4. The biochip detection device as claimed in claim 1, wherein the biochip is made with a complementary metal oxide semiconductor (CMOS) process or a CMOS-compatible process.

5. The biochip detection device as claimed in claim 1, wherein the first and second amplifiers are respectively an inverted closed-loop amplifier and a non-inverted closed-loop amplifier.

6. The biochip detection device as claimed in claim 1, wherein the first and second voltage sources are selected as direct-current (DC) voltage sources or alternate-current (AC) voltage sources.

7. The biochip detection device as claimed in claim 1, wherein the detection circuit further comprise an externally applied magnetic field that is either an AC field or a DC field.

8. A detection method of a biochip detection device for detecting existence of target molecules, the detection method comprising the following steps:
(a) providing a biochip: in which the biochip comprises a plurality of biosensor modules, each biosensor module comprising a plurality of GMR biosensors;
(b) surface functionalization: in which surface functionalization is carried out on each biosensor;
(c) immobilization of probe molecule: in which a surface of each biosensor is spotted with a probe molecule corresponding to the target molecule to complete molecule immobilization;
(d) application of sample: in which a purified sample is applied to the biochip so that target molecules existing in the sample bind to the probe molecules on the surfaces of the biosensors;
(e) application of detecting molecule: in which detecting molecules that are combined with magnetic nano-particles are applied to the biochip, wherein the detecting molecules are complementary to and thus bound to the target molecules; and
(f) measurement of output of detection value: in which at least one detection circuit is used to supply an output of a detection current of the biosensors and observation of variation thereof is made to determine existence of the target molecules.

9. A detection method of a biochip detection device for detecting existence of target molecules, the detection method comprising the following steps:
(a) providing a biochip: in which the biochip comprises a plurality of biosensor modules, each biosensor module comprising a plurality of GMR biosensors;
(b) surface functionalization: in which surface functionalization is carried out on each biosensor;
(c) immobilization of probe molecule: in which a surface of each biosensor is spotted with a probe molecule corresponding to the target molecule to complete molecule immobilization;
(d1) combination of detecting molecule with target molecule: in which detecting molecules carrying magnetic nano-particles are combined in advance with target molecules contained in a sample in an external environment;
(d2) purification of sample: in which an external magnetic field is applied to the external environment to purify the sample;
(e) application of sample: in which the purified sample with magnetic nano-particles attached thereto is applied to the biochip to bind to the probe molecules on the surfaces of the biosensors; and
(f) measurement of output of detection value: in which at least one detection circuit is used to supply an output of a detection current of the biosensors and observation of variation thereof is made to determine existence of the target molecules.

10. The detection method as claimed in claim 8, wherein the detection circuit comprises a first voltage source, a second voltage source, a plurality of reference sensors, a first amplifier, a second amplifier, and a third amplifier, the first voltage source being electrically connected to an end of each biosensor of the modules to apply a voltage thereto, each biosensor having an opposite end connected to the first amplifier that supplies an output of detection current, a reference sensor being set beside each biosensor, each reference sensor having an end connected to the second voltage source to be applied with a voltage and an opposite end connected to the second amplifier that supplies an output of reference current, the third amplifier receiving the outputs of the first and second amplifiers and, after making a comparison, supplying a final detection value through which observation of variation can be made.

11. The detection method as claimed in claim 9, wherein the detection circuit comprises a first voltage source, a second voltage source, a plurality of reference sensors, a first amplifier, a second amplifier, and a third amplifier, the first voltage source being electrically connected to an end of each biosensor of the modules to apply a voltage thereto, each biosensor having an opposite end connected to the first amplifier that supplies an output of detection current, a reference sensor being set beside each biosensor, each reference sensor having an end connected to the second voltage source to be applied with a voltage and an opposite end connected to the second amplifier that supplies an output of reference current, the third amplifier receiving the outputs of the first and second amplifiers and, after making a comparison, supplying a final detection value through which observation of variation can be made.
